(19) United States
(12) Patent Application Publication
(10) Pub. No.: US 2025/0007912 A1
(43) Pub. Date: Jan. 2, 2025

(54) INFORMATION PROCESSING SYSTEM, NON-TRANSITORY COMPUTER READABLE MEDIUM, AND METHOD

(71) Applicant: FUJIFILM Business Innovation Corp., Tokyo (JP)

(72) Inventor: Hiroaki Shimba, Kanagawa (JP)

(73) Assignee: FUJIFILM Business Innovation Corp., Tokyo (JP)

(21) Appl. No.: 18/521,441

(22) Filed: Nov. 28, 2023

(30) Foreign Application Priority Data
Jun. 27, 2023 (JP) 2023-104643

(51) Int. Cl. H04L 9/40

(52) U.S. Cl. CPC H04L 63/0884

(57) ABSTRACT

An information processing system includes a processor included in a server that manages second information processing apparatuses, each of which, if authentication with a pair of information for proving that the second information processing apparatus and one of first information processing apparatuses form a pair is successfully completed, is operable in conjunction with the first information processing apparatus, which holds one of the pair of information, and holds another of the pair of the information, the processor configured to: cause the server to hold proxy relationship information in which proxy relationships between the first information processing apparatuses are set; send back, if, after the processor receives, from a first information processing apparatus that operates as a proxy apparatus in accordance with a proxy authentication request from another first information processing apparatus that operates as a proxy authentication request apparatus, a first authentication request that specifies one of a pair of information held by the proxy apparatus and a second authentication request for authenticating the proxy authentication request apparatus, authentication with the pair of information specified by the first authentication request is successfully completed and the proxy apparatus is servable as a proxy apparatus for the proxy authentication request apparatus according to the proxy relationship information, authentication information for authenticating the proxy authentication request apparatus; and authenticate, if the authentication information sent back to the proxy apparatus is added to communication data transmitted from the proxy authentication request apparatus, the proxy authentication request apparatus, even if a compromise of the one of the pair of information held by the proxy authentication request apparatus has been detected.

### CROSS-REFERENCE TO RELATED APPLICATIONS

This application is based on and claims priority under 35 USC 119 from Japanese Patent Application No. 2023-104643 filed Jun. 27, 2023.

### BACKGROUND

### (i) Technical Field

The present disclosure relates to an information processing system, a non-transitory computer readable medium, and a method.

### (ii) Related Art

Techniques for providing a cloud service while linking an actual multifunction peripheral (MFP) and a digital copy (hereinafter also referred to as a “virtual device”) in a cloud environment corresponding to the MFP with each other are known. A user can use a service such as image processing provided by the MFP by accessing the virtual device in the cloud environment without directly accessing the MFP.

In such a service system, a technique for checking authenticity of a device using a public key and a private key of public-key cryptography in order to prevent spoofing by a fake device is known. More specifically, an MFP (hereinafter also referred to as an “actual device”) holds a private key thereof, makes a virtual device hold a public key thereof, and associates the public key and the private key (hereinafter referred to as a “pair of keys”) with each other. Usually, different pairs of keys are generated for different devices in order to minimize a scope of impact of leakage. A server in a cloud environment that manages virtual services receives, from an actual device, a processing request including authentication information created using a private key (e.g., a digital signature created using a private key) and authenticates the actual device using a public key before starting to perform processing in conjunction with a virtual device. If the server successfully completes the authentication, the actual device can operate in conjunction with the virtual device.

The server monitors a possible compromise due to leakage of a private key or the like. If a compromise of a private key is detected, the server does not successfully authenticate an actual device. In other words, the authentication of the actual device using a private key of the actual device fails.

For example, refer to Japanese Unexamined Patent Application Publication Nos. 2017-059153, 2015-019267, and 2015-177453.

### SUMMARY

A condition where a first information processing apparatus can operate in conjunction with a second information processing apparatus as a result of successful authentication based on a pair of information for proving that the first information processing apparatus and the second information processing apparatus form a pair means that the first information processing apparatus cannot operate in conjunction with the second information processing apparatus unless the authentication is successfully completed. In order to eliminate this state, for example, there is a method where another information processing apparatus whose authenticity has been verified undergoes the authentication by proxy (e.g., refer to Japanese Unexamined Patent Application Publication No. 2017-059153).

If a user is asked to input various settings or take other measures after it is found that authentication has failed, however, the user undesirably needs to take action to achieve successful authentication.

Aspects of non-limiting embodiments of the present disclosure relate to achievement of successful authentication without a user taking any measures even if, in an information processing system where a first information processing apparatus that holds one of a pair of information for proving that the first information processing apparatus and a second information processing apparatus form a pair can operate in conjunction with a second information processing apparatus that holds another of the pair of information if authentication based on the pair of information is successfully completed, a server that manages the second information processing does not successfully authenticate the first information processing apparatus using the pair of information.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor included in a server that manages second information processing apparatuses, each of which, if authentication with a pair of information for proving that the second information processing apparatus and one of first information processing apparatuses form a pair is successfully completed, is operable in conjunction with the first information processing apparatus, which holds one of the pair of information, and holds another of the pair of the information, the processor configured to: cause the server to hold proxy relationship information in which proxy relationships between the first information processing apparatuses are set; send back, if, after the processor receives, from a first information processing apparatus that operates as a proxy apparatus in accordance with a proxy authentication request from another first information processing apparatus that operates as a proxy authentication request apparatus, a first authentication request that specifies one of a pair of information held by the proxy apparatus and a second authentication request for authenticating the proxy authentication request apparatus, authentication with the pair of information specified by the first authentication request is successfully completed and the proxy apparatus is servable as a proxy apparatus for the proxy authentication request apparatus according to the proxy relationship information, authentication information for authenticating the proxy authentication request apparatus; and authenticate, if the authentication information sent back to the proxy apparatus is added to communication data transmitted from the proxy authentication request apparatus, the proxy authentication request apparatus, even if a compromise of the one of the pair of information held by the proxy authentication request apparatus has been detected.

### BRIEF DESCRIPTION OF THE DRAWINGS

Exemplary embodiments of the present disclosure will be described in detail based on the following figures, wherein:

FIG. 1 is a diagram illustrating an overall configuration of a service system according to an exemplary embodiment;

FIG. 2 is a diagram illustrating a block configuration of the service system according to the exemplary embodiment;

FIG. 3 is a diagram illustrating a first registration method for registering proxy relationship information according to the exemplary embodiment;

FIG. 4 is a diagram illustrating a second registration method for registering proxy relationship information according to the exemplary embodiment;

FIG. 5 is a diagram illustrating a third registration method for registering proxy relationship information according to the exemplary embodiment; and

FIG. 6 is a sequence diagram illustrating proxy authentication according to the exemplary embodiment.

### DETAILED DESCRIPTION

An exemplary embodiment of the present disclosure will be described hereinafter on the basis of the drawings.

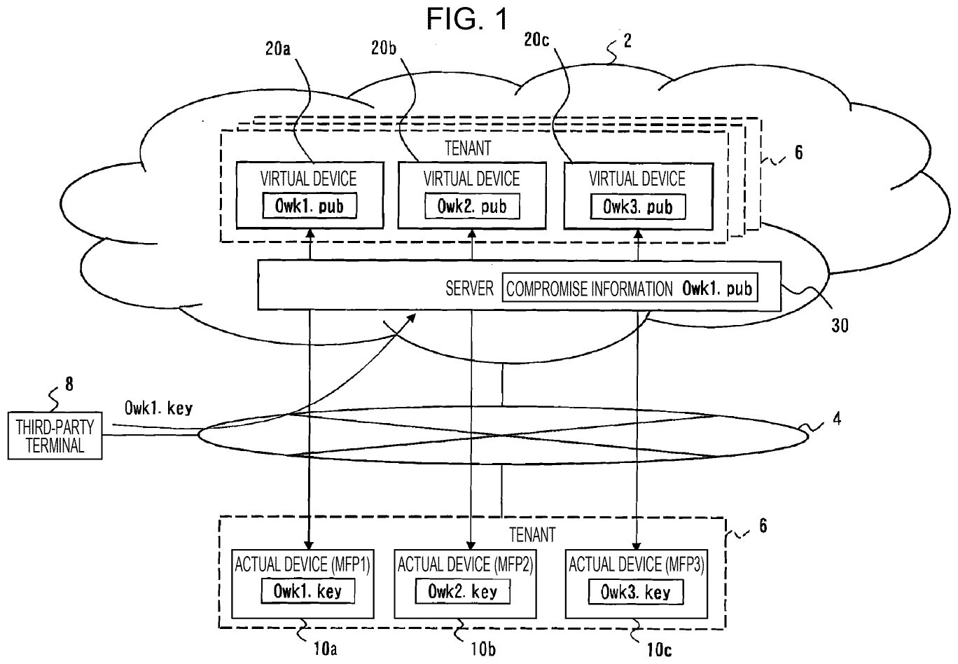

FIG. 1 is a diagram illustrating an overall configuration of a service system according to the present exemplary embodiment. The service system according to the present exemplary embodiment is a mode of an information processing system in the present disclosure. FIG. 1 illustrates a configuration where MFPs 10a, 10b, and 10c installed in an on-premise environment and virtual MFPs 20a, 20b, and 20c provided in a cloud environment 2 are connected to each other over a network 4 such as the Internet.

The MFPs 10a, 10b, and 10c will be collectively referred to as “MFPs 10” when the MFPs 10a, 10b, and 10c need not be distinguished from one another. The same holds for the MFPs 20a, 20b, and 20c. Since the MFPs 10 as first information processing apparatuses are actual devices physically installed in the on-premise environment, the MFPs 10 will also be referred to as “actual devices 10” in the following description. Since the MFPs 20 as second information processing apparatuses are virtually provided in the cloud environment 2, on the other hand, the MFPs 20 will also be referred to as “virtual devices 20” in the following description.

The actual devices 10 hold data used to provide certain services. The virtual devices 20 operate in conjunction with the actual devices 10 and provide the certain services like the actual devices 10. For this purpose, the virtual devices 20 hold the data held by the actual devices 10 as a target to be synchronized. The virtual devices 20 thus synchronize the data held by the actual devices 10 and are regarded as digital copies of the actual devices 10. A server 30 provided in the cloud environment 2 manages the virtual devices 20 in units of tenants 6. The actual devices 10 corresponding to the virtual devices 20 also have tenants 6.

The tenants 6 are a unit for managing cloud services provided by the service system and users of the cloud services. Persons who use the tenants 6 are called “users”, and users with administrative rights are called “administrators”. The administrators are classified into those who administer all the tenants 6, those who administer a subset of the tenants 6, those who administer services, and the like.

In order for the actual devices 10 and the virtual devices 20 to provide the same services for the users, data needs to be synchronized between the actual devices 10 and the virtual devices 20 as described above. The “synchronization of data” basically refers to mutual holding of the same data. Part (also called a “subset”) of software in the virtual devices 20 might also exist in the MFPs 10. The term “synchronization of data” should thus not be interpreted that data held by the actual devices 10 and the virtual devices 20 is exactly the same. In the present exemplary embodiment, the “synchronization of data” refers to establishment, through cooperation between the MFPs 10 and the MFPs 20, of a state where the MFPs 10 and the MFPs 20 can provide services to be provided using data.

The “data” includes applications, data used by the applications, and various setting values for the MFPs 10 and 20. That is, in the present exemplary embodiment, electronic data referred to by the MFPs 10 and 20 for operation will be generically referred to as “data”. When data is applications, the applications need to be synchronized through version upgrades, addition of functions, or the like.

FIG. 1 illustrates the virtual devices 20a, 20b, and 20c corresponding to the actual devices 10a, 10b, and 10c, respectively. Although the actual devices 10 and the virtual devices 20 are in one-to-one correspondence in the present exemplary embodiment, plural actual devices 10 may be associated with a single virtual device 20, instead. Although FIG. 1 illustrates there pairs of devices, it is only required in the present exemplary embodiment that two or more pairs are provided.

An actual device 10 and a virtual device 20 paired with the actual device 10 each hold one of owner authentication keys, which are a pair of information for proving that the actual device 10 and the virtual device 20 form a pair. The owner authentication keys are a pair of keys consisting of a private key and a public key. In FIG. 1, private keys are represented as “Owki.key” (i=1, 2, or 3) and public keys are represented as “Owkj.pub” (j=1, 2, or 3), and owner authentication keys with the same value of i and j form a pair. A case where owner authentication keys based on public-key cryptography are used will be described as an example in the present exemplary embodiment, but owner authentication keys based on public-key cryptography need not necessarily be used insofar as a pair of information for proving that an actual device 10 and a virtual device 20 form a pair is used.

The MFPs 10 according to the present exemplary embodiment are a mode of image forming apparatuses having various functions such as a printing function, a copying function, and a scanning function and apparatuses with a built-in information processing device (also called a “computer”). The MFPs 10 according to the present exemplary embodiment may be achieved by an existing general-purpose hardware configuration. That is, the MFPs 10 each include a central processing unit (CPU), a read-only memory (ROM), a random-access memory (RAM), storage means storing image data, a confidential box, and the like such as a hard disk drive (HDD), an operation panel as a user interface, the network 4 such as the Internet, and a scanner, a print engine, and other devices for providing the various functions.

The MFPs 10 according to the present exemplary embodiment each include a hardware security module (HSM) such as a trusted platform module (TPM) as means for saving a key. The HSM is a hardware device with enhanced tamper-resistant features that secure an encryption process by encrypting and decrypting data and generating, protecting, and managing a key used to create a digital signature and a certificate and fixed to a board.

The MFPs 20 are a mode of virtual image forming apparatuses achieved by one or more computers and include an information processing apparatus. The server 30 is a mode of a virtual server computer achieved by one or more computers. Although the MFPs 20 and the server 30 are virtual apparatuses, the MFPs 20 and the server 30 each include a CPU, a ROM, a RAM, storage means, and communication means. Although the MFPs 20 and the server 30 are each illustrated as a single apparatus for convenience of description, the MFPs 20 and the server 30 may each be achieved by combining together plural information processing apparatuses, instead.

FIG. 1 also illustrates a third-party terminal 8 connected to the network 4. The third-party terminal 8 is an information processing apparatus that is not originally included in the service system according to the present exemplary embodiment and is used by an unauthorized user of the services. The server 30 monitors compromises of private keys and manages, as compromise information, public keys paired with private keys for which compromises have been detected. FIG. 1 illustrates a case where a compromise has been detected because the public key “Owk1.key” has been leaked to the user of the third-party terminal 8.

Since the legitimate actual device 10a included in one of the tenants 6 is a physical device, an installation location of the actual device 10a remains basically the same and a mode of connection with the network 4 does not change. The actual device 10a, therefore, usually accesses the virtual device 20a using the private key “Owk1.key” through the same communication path. If the third-party terminal 8 accesses the virtual device 20a using the private key “Owk1.key”, on the other hand, the server 30 determines, on the basis of a fact that a communication path used is different from the usual one, that the private key “Owk1.key” might have been leaked. This is just an example, but the server 30 detects a compromise of a private key in this manner. A “compromise” may include not only a case where a compromise has actually occurred but also a case where a compromise can occur. A technique for detecting a compromise itself may be the same as a conventional one.

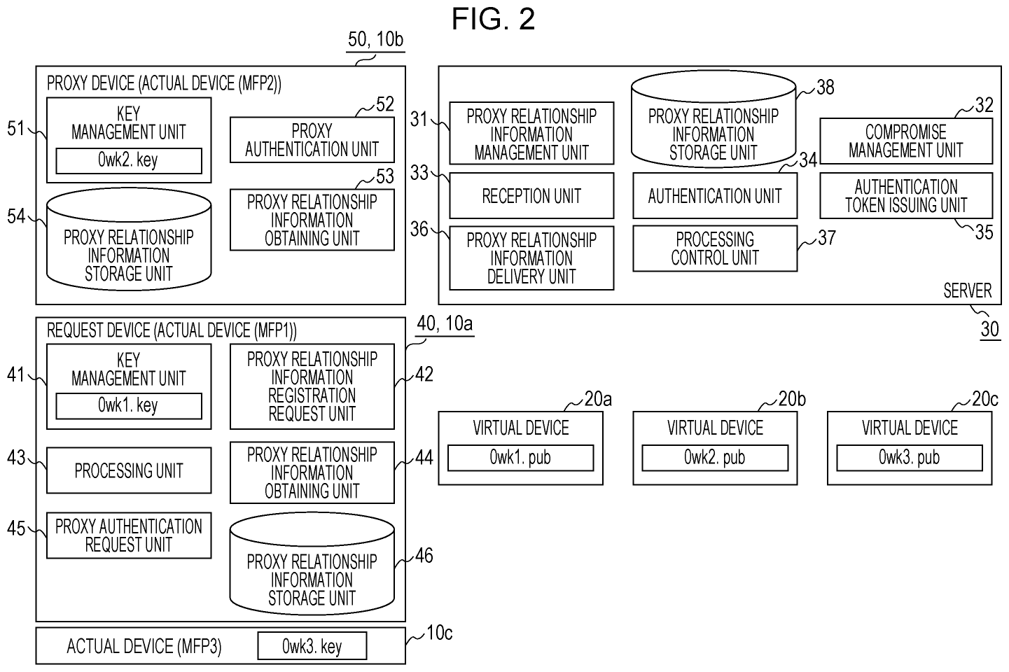

FIG. 2 is a diagram illustrating an example of a block configuration of the service system according to the present exemplary embodiment. The actual devices 10 illustrated in FIG. 1 have both functions of a request device 40 that operates as a proxy authentication request apparatus illustrated in FIG. 2 that requests proxy authentication when registered to proxy relationship information and functions of a proxy device 50 that operates as a proxy apparatus that undergoes authentication by proxy in accordance with a request, but FIG. 2 separately illustrates functional blocks for convenience of description. The actual devices 10 obviously provide a plurality of functions including the printing function and the scanning function, but such functions are omitted from the drawings in the present exemplary embodiment because these functions are not used for description. FIG. 2 illustrates a case where the actual device 10a serves as the request device 40 and the actual device 10b serves as the proxy device 50 as an example.

The request device 40 includes a key management unit 41, a proxy relationship information registration request unit 42, a processing unit 43, a proxy relationship information obtaining unit 44, a proxy authentication request unit 45, and a proxy relationship information storage unit 46. The key management unit 41 is achieved by the above-described HSM and holds and manages an owner authentication key. The proxy relationship information registration request unit 42 requests the server 30 to register proxy relationship information. The processing unit 43 performs processing for operating in conjunction with the virtual devices 20. The proxy relationship information obtaining unit 44 obtains proxy relationship information transmitted from the server 30. The proxy authentication request unit 45 requests the proxy device 50 to undergo authentication by proxy. The proxy relationship information storage unit 46 stores proxy relationship information obtained by the proxy relationship information obtaining unit 44.

The components 41 to 45 of the request device 40 are achieved by cooperation between a computer included in the request device 40 and a program executed by a CPU included in the computer. The proxy relationship information storage unit 46 is achieved by an HDD included in the request device 40. Alternatively, a RAM or external storage means may be used over a network.

The proxy device 50 includes a key management unit 51, a proxy authentication unit 52, a proxy relationship information obtaining unit 53, and a proxy relationship information storage unit 54. The key management unit 51 is achieved by the above-described HSM and holds and manages an owner authentication key. The proxy authentication unit 52 performs authentication by proxy in accordance with a proxy authentication request from the request device 40. The proxy relationship information obtaining unit 53 obtains proxy relationship information transmitted from the server 30. The proxy relationship information storage unit 54 stores proxy relationship information obtained by the proxy relationship information obtaining unit 53.

The components 51 to 53 of the proxy device 50 are achieved by cooperation between a computer included in the proxy device 50 and a program executed by a CPU included in the computer. The proxy relationship information storage unit 54 is achieved by an HDD included in the proxy device 50. Alternatively, a RAM or external storage means may be used over a network.

The server 30 includes a proxy relationship information management unit 31, a compromise management unit 32, a reception unit 33, an authentication unit 34, an authentication token issuing unit 35, a proxy relationship information delivery unit 36, a processing control unit 37, and a proxy relationship information storage unit 38. The proxy relationship information storage unit 38 stores proxy relationship information, but the proxy relationship information management unit 31 manages, that is, registers, edits, and deletes, for example, the proxy relationship information. The compromise management unit 32 detects a compromise of a private key and holds and manages a public key corresponding to the compromised private key as compromise information. The reception unit 33 receives requests, such as an authentication request and a processing request, and information transmitted from the actual devices 10. The authentication unit 34 authenticates an actual device 10 in accordance with an authentication request including a private key from the actual device 10. The authentication token issuing unit 35 issues an authentication token used for communication through a session established when the authentication unit 34 has successfully completed authentication in accordance with an authentication request. The proxy relationship information delivery unit 36 delivers proxy relationship information stored in the proxy relationship information storage unit 38 to an actual device 10 set in the proxy relationship information. The processing control unit 37 controls processing performed by the server 30. The proxy relationship information storage unit 38 stores proxy relationship information as described above. Creation and data configuration of proxy relationship information will be described later.

The components 31 to 37 of the server 30 are achieved by cooperation between a computer for achieving the server 30 and a program executed by a CPU included in the computer. The proxy relationship information storage unit 38 is achieved by an HDD included in the server 30. Alternatively, a RAM or another storage means in the cloud environment may be used.

The programs used in the present exemplary embodiment may be obviously provided through communication means or stored in a computer readable storage medium such as a USB memory and provided. A program provided from communication means or a storage medium is installed on a computer, and various types of processing are achieved when a CPU included in the computer sequentially executes the program.

Next, operations in the present exemplary embodiment will be described. First, operations performed by the actual device 10a before a compromise of the private key “Owk1.key” is detected will be described. The actual device 10a achieves the functions of the request device 40 after a compromise of the private key “Owk1.key” is detected. That is, in the description of the operations, the “actual device 10a” and the “request device 40” refer to the same MFP 10.

The processing unit 43 of the actual device 10a transmits an authentication request including authentication information created using the private key “Owk1.key” to the server 30 in order to perform processing in conjunction with the virtual device 20a.

When the reception unit 33 of the server 30 receives the authentication request from the actual device 10a, the authentication unit 34 verifies the authentication information included in the authentication request using the public key to authenticate the actual device 10a. Since a compromise of the private key “Owk1.key” has not been detected at a time of the authentication, the actual device 10a successfully completes the authentication using the private key “Owk1.key”. After the authentication is successfully completed, the authentication token issuing unit 35 issues an authentication token used for communication with the actual device 10a. The authentication unit 34 notifies the actual device 10a that the authentication has been successfully completed by sending back the authentication token to the actual device 10a in response to the authentication request. As a result, the actual device 10a can start to operate in conjunction with the virtual device 20a using the authentication token.

If the compromise management unit 32 detects a compromise of the private key “Owk1.key” thereafter, the actual device 10a no longer successfully completes authentication using the private key “Owk1.key”. An administrator of the actual device 10a, therefore, registers, to the server 30, proxy relationship information in advance when or immediately after the actual device 10a is installed, that is, at least before a compromise is detected, for example, in order to deal with a possible compromise of the private key “Owk1.key”. A process for registering proxy relationship information will be described hereinafter. In the present exemplary embodiment, three registration methods are prepared for the process for registering proxy relationship information. The server 30 naturally creates proxy relationship information on the basis of a registration request from an actual device 10 with which a compromise of a private key has not been detected and holds the proxy relationship information in the proxy relationship information storage unit 38.

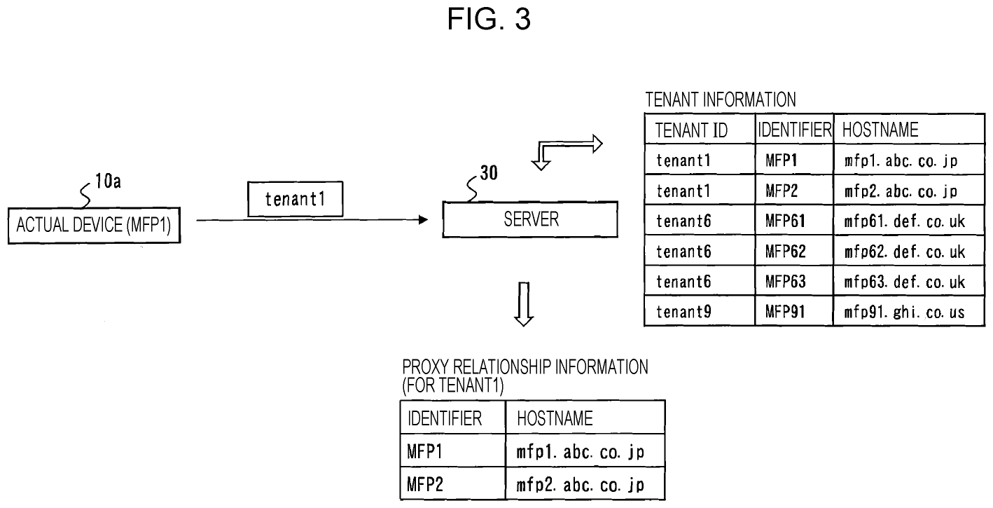

FIG. 3 is a diagram illustrating a first registration method for registering proxy relationship information. Although not illustrated in FIG. 2, the first registration method can be used when the server 30 holds tenant information for managing the tenants 6. In addition, the MFPs 10 and 20 need to be classified into one of groups, that is, the tenants 6, and managed. When an actual device 10 is installed, tenant information regarding the actual device 10 is registered to the server 30. As illustrated in FIG. 3, tenant information is set by associating identification information (tenant identifier (ID)) regarding a tenant, identification information (identifier) regarding an actual device 10 belonging to the tenant, and a hostname of the actual device 10 with one another.

The administrator of the actual device 10a inputs and sets a tenant ID indicating a tenant 6 to which the actual device 10a belongs using an operation panel of the actual device 10a or the like when installing the actual devices 10. The proxy relationship information registration request unit 42 transmits a registration request for registering proxy relationship information including the tenant information to the server 30 in accordance with this setting operation.

The proxy relationship information management unit 31 of the server 30 creates proxy relationship information corresponding to “tenant1”, to which the actual device 10a belongs, in accordance with the registration request from the actual device 10a. When the server 30 recognizes an identifier and a hostname of the actual device 10a but does not know a tenant to which the actual device 10a belongs, the server 30 may register “tenant1”, to which the actual device 10a belongs, to the tenant information in accordance with the registration request from the actual device 10a. When the server 30 does not hold the tenant information regarding the actual device 10a, the server 30 identifies a tenant ID, the identifier, and the hostname of the actual device 10a from the registration request, registers the tenant ID, the identifier, and the hostname to the tenant information, and, as described above, creates proxy relationship information. In the first registration method for registering proxy relationship information, proxy relationship information is created for each tenant as described above.

As the actual device 10a is installed, proxy relationship information for “tenant1” illustrated in FIG. 3 is created. That is, according to an example of set tenant information illustrated in FIG. 3, the actual device 10b is installed before the actual device 10a. The actual device 10c, on the other hand, is not installed yet when the actual device 10a is installed. If the actual device 10b issues a registration request for registering proxy relationship information before the actual device 10a does, proxy relationship information created in accordance with the registration request from the actual device 10b includes only information regarding the actual device 10b. That is, records included in pieces of proxy relationship information corresponding to the actual device 10a and the actual device 10b belonging to the same tenant are different, even though the pieces of proxy relationship information are both created for “tenant1”. In this case, the pieces of proxy relationship information may be merged together and shared between the actual device 10a and the actual device 10b. Details of the sharing of proxy relationship information will be described later.

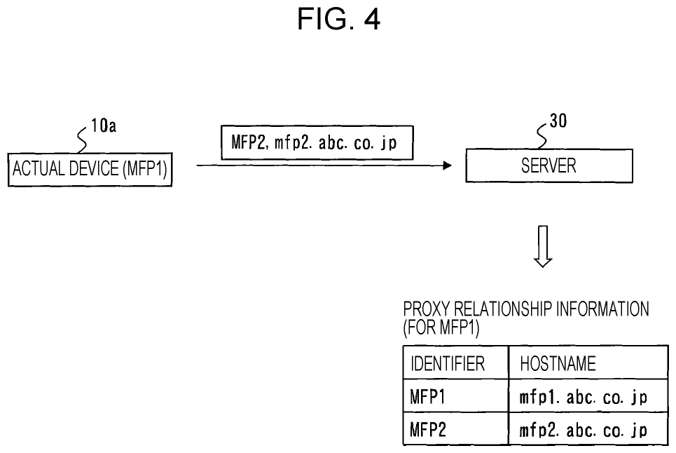

FIG. 4 is a diagram illustrating a second registration method for registering proxy relationship information. In the second registration method, not identification information regarding a tenant but an identifier and a hostname are specified as apparatus information for identifying an actual device 10 for which a proxy relationship for authentication is to be established. That is, when installing the actual devices 10, the administrator of the actual device 10a inputs, using the operation panel of the actual device 10a or the like, an identifier and a hostname of an actual device 10 (the actual device 10b in this example) with which a proxy relationship for authentication is to be established. The proxy relationship information registration request unit 42 transmits a registration request for registering proxy relationship information including the identifier and the hostname of the actual device 10b to the server 30 in accordance with this setting operation.

If the registration request from the actual device 10a specifies the identifier and the hostname, the proxy relationship information management unit 31 of the server 30 creates proxy relationship information including the identifier and the hostname of the actual device 10a, from which the registration request has been transmitted, and the identifier and the hostname of the actual device 10b, which is specified by the registration request. Information regarding a device from which a registration request has been transmitted can be obtained by referring to a header of registration request data or the like. Since the proxy relationship information is created in accordance with the registration request from the actual device 10a, the proxy relationship information is for the actual device 10a (“MFP1”) as illustrated in FIG. 4.

Although the proxy relationship information registration request unit 42 specifies one actual device 10 in accordance with an input from the administrator in the above description, plural actual devices 10 may be specified in a registration request, instead. The same holds for a third registration method, which will be described hereinafter.

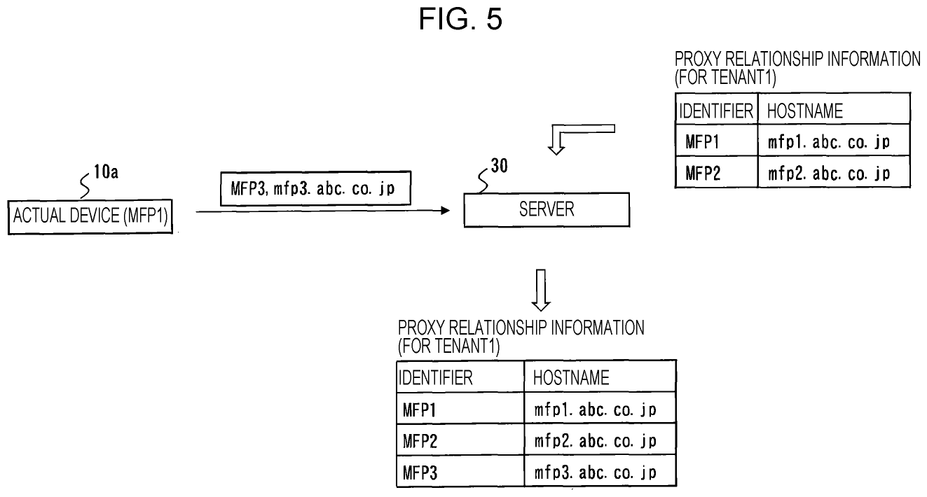

FIG. 5 is a diagram illustrating a third registration method for registering proxy relationship information. Whereas the second registration method is used when the actual device 10a is installed, the third registration method is used to additionally register an actual device 10 for which a proxy relationship is to be established after the installation. That is, if the administrator of the actual device 10a desires to add the actual device 10c to proxy relationship information registered in the server 30 by the first or second registration method when the actual devices 10 are installed, the administrator inputs and sets, using the operation panel of the actual device 10a or the like, an identifier and a hostname of an actual device 10 (the actual device 10c in this example) with which a proxy relationship for authentication is to be established. The proxy relationship information registration request unit 42 transmits, to the server 30, a registration request for registering proxy relationship information including the identifier and the hostname of the actual device 10c in accordance with this setting operation.

If a registration request from the actual device 10a specifies an identifier and a hostname, the proxy relationship information management unit 31 of the server 30 checks presence or absence of proxy relationship information including the identifier and the hostname of the actual device 10a, from which the registration request has been transmitted. If proxy relationship information has not been created, proxy relationship information including the identifier and the hostname of the actual device 10a, from which the registration request has been transmitted, and the identifier and the hostname of the actual device 10c, which is specified by the registration request, is created as in the second registration method. Since the proxy relationship information including the actual device 10a has already been created here, the proxy relationship information management unit 31 additionally registers the identifier and the hostname of the actual device 10c, which is specified by the registration request, to the proxy relationship information including the information regarding the actual device 10a, from which the registration request has been transmitted. As a result, for example, when the actual device 10c is installed after the actual device 10a is installed, the administrator can cause the actual device 10c to undergo authentication by proxy.

As described above, proxy relationships for authentication between the actual devices 10 are set in the proxy relationship information. That is, since actual devices 10 requested to undergo authentication by proxy are set, there is a relationship of trust between the actual devices 10 for which proxy relationships are established where an actual device 10 can request another actual device 10 to undergo authentication on behalf thereof. For this reason, it is estimated that there are relationships of trust between actual devices 10 belonging to the same tenant 6, and proxy relationship information is created in the first registration method in such a way as to include the actual devices 10 belonging to the same tenant 6. In the second and third registration methods, too, the administrator of the actual device 10a is likely to be an administrator of the actual devices 10b and 10c belonging to the same tenant 6 or, even if the administrator of the actual device 10a is not the administrator of the actual devices 10b and 10c, know the identifiers and the hostnames of the actual devices 10b and 10c since there are relationships of trust. In the second and third registration methods, actual devices 10 to be included in proxy relationship information need not belong to the same tenant 6.

In view of groups (the above-described tenants) in relationships of trust, it can be considered that it is appropriate to share proxy relationship information including more actual devices 10 between the actual devices 10 included in the proxy relationship information. As described in relation to the first registration method, proxy relationship information created in accordance with a registration request from the actual device 10b includes only the information regarding the actual device 10b. Proxy relationship information created thereafter in accordance with a registration request from the actual device 10a includes the information regarding the actual device 10a and the actual device 10b. The latter proxy relationship information, which includes more actual devices 10, may be used as proxy relationship information for the tenant ID “tenant1” and shared.

In the second and third registration methods, too, proxy relationship information may be shared between actual devices 10 set in the proxy relationship information. Since devices with which proxy relationships are established are specified in the second and third registration methods, however, proxy relationship information need not be shared as illustrated in FIG. 4 and created for each actual device 10.

As described above, when proxy relationship information is shared, the proxy relationship information delivery unit 36 may deliver the proxy relationship information to each of actual devices 10 whose identities and hostnames are registered in the proxy relationship information after the proxy relationship information is created. As a result, the proxy relationship information is shared between actual devices 10 belonging to the same tenant 6. The proxy relationship information obtaining units 44 and 53 of the actual devices 10 store proxy relationship information transmitted from the server 30 in the proxy relationship information storage units 46 and 54, respectively.

As in the case of proxy relationship information illustrated in FIG. 5, plural actual devices 10 other than the request device 40 might be registered. In this case, the request device 40 needs to select an actual device 10 that is to actually undergo authentication by proxy from among the actual devices 10 other than the request device 40. In this case, for example, the request device 40 may give order of priority to the actual devices 10 registered in the proxy relationship information. For example, order of registration to the proxy relationship information may be simply used as the order of priority. Alternatively, the order of priority may be given on the basis of processing performance of the other actual devices 10 or the like, or the administrator may manually set the order of priority and the order of priority may be added to the proxy relationship information and saved.

Although an actual device 10 that is to undergo authentication by proxy is registered to proxy relationship information in the present exemplary embodiment, an actual device 10 that is not to undergo authentication by proxy may also be explicitly specified and registered to the proxy relationship information.

Although only the process for requesting registration of proxy relationship information has been described, proxy relationship information may be registered along with another process performed when the actual device 10a is installed, such as setting and registration of information regarding the actual device 10a to the server 30, a request to create a corresponding virtual device 20, or a registration request for registering a public key to the virtual device 20a, since the proxy relationship information is registered when the actual device 10a is installed. In other words, the server 30 may register proxy relationship information along with the setting and registration of the information regarding the actual device 10a, the creation of the virtual device 20a, the registration of a public key to the virtual device 20a, or the like.

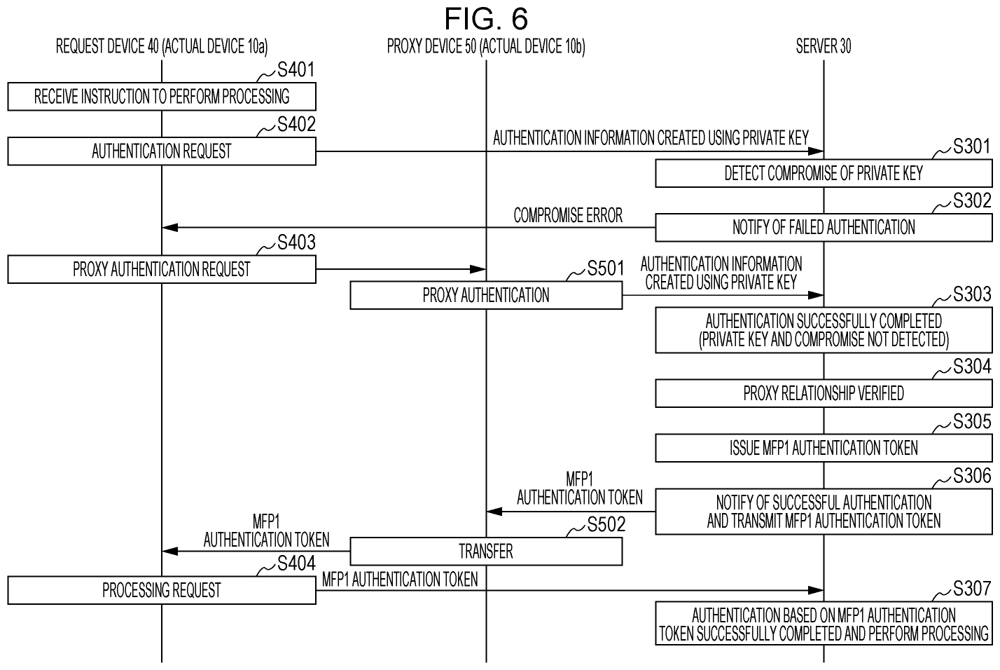

In the present exemplary embodiment, proxy relationship information is registered to the server 30 in the above-described manner as preparation for detection of a possible compromise of a private key. Next, proxy authentication performed after a compromise of a private key is detected will be described with reference to a sequence diagram of FIG. 6.

The processing unit 43 of the actual device 10a receives an instruction to perform processing for operating in conjunction with a virtual device 20 for a reason such as a need to synchronize data (step S401) and transmits, to the server 30, an authentication request including authentication information created using the private key “Owk1.key” thereof (step S402).

The reception unit 33 of the server 30 receives the authentication request transmitted from the actual device 10a, and the authentication unit 34 verifies the authentication information included in the authentication request using a public key to perform authentication. More specifically, the authentication unit 34 checks authenticity using a public key “Owk1.pub” held by the virtual device 20a and presence or absence of detection of a compromise of the private key “Owk1.key”. If the authentication with the private key “Owk1.key” is successfully completed, the actual device 10a can operate in conjunction with the virtual device 20 as before.

It is assumed here that the compromise management unit 32 has detected a compromise of the private key “Owk1.key” of the actual device 10a (step S301). In this case, the authentication unit 34 sends back a status “compromise error” to the actual device 10a to notify of failed authentication since the compromise of the private key “Owk1.key” has been detected (step S302).

When “compromise error” is sent back in response to the authentication request to the server 30, the proxy authentication request unit 45 requests the actual device 10b, which can be identified by referring to proxy relationship information, to undergo the authentication by proxy by transmitting a proxy authentication request to the actual device 10b (step S403). As a result of the request to undergo the authentication by proxy, the actual device 10a turns into the request device 40, and the actual device 10b turns into the proxy device 50.

The administrator may be notified of occurrence of “compromise error”, for example, on the operation panel of the actual device 10a or by email.

As described above, a proxy authentication request is automatically issued in accordance with reception of “compromise error” in the present exemplary embodiment. This is because no problem arises even if proxy authentication is automatically performed without checking with a person who has given an instruction to perform processing, the administrator, or another person, since the actual device 10a has received the instruction in step S401 and the authentication has failed. If the actual device 10a receives “compromise error”, however, the actual device 10a may enter a mode different from a normal operation model, such as a compromise mode, and returns an authentication result “authentication failure” to the person who has given the instruction in step S401. The actual device 10a may then issue the proxy authentication request (step S403) in accordance with reception of an instruction to perform processing in the compromise mode.

Upon receiving the proxy authentication request from the request device 40, the proxy authentication unit 52 of the proxy device 50 performs the proxy authentication with the server 30 (step S501). When performing the proxy authentication, the proxy authentication unit 52 transmits, to the server 30, not only a request to authenticate the proxy device 50, which is a first authentication request, including authentication information created using a private key “Owk2.key” of the proxy device 50 but also a request to authenticate the request device 40, which is a second authentication request and indicates that the proxy device 50 is undergoing the authentication on behalf of the request device 40. In the second authentication request, information with which the server 30 can recognize that the proxy device 50 is undergoing the authentication on behalf of the request device 40 is set by, for example, including the identifier and the hostname of the request device 40 in the second authentication request.

The reception unit 33 of the server 30 receives the authentication request transmitted from the actual device 10b, and the authentication unit 34 performs authentication using the authentication information created using the private key “Owk2.key” included in the first authentication request. More specifically, the authentication unit 34 checks authenticity using a public key “Owk2.pub” held by the virtual device 20b and presence or absence of detection of a compromise of the private key “Owk2.key”.

If the authentication with the private key “Owk2.key” included in the first authentication request is successfully completed and a compromise of the private key “Owk2.key” has not been detected, the actual device 10b, which is operating as the proxy device 50, successfully completes the authentication performed by the server 30 (step S303).

Next, in the case of proxy authentication, the authentication unit 34 checks presence or absence of a proxy relationship between the actual device 10b and the actual device 10a by referring to the proxy relationship information. Since the actual device 10b can undergo authentication on behalf of the actual device 10a in the present exemplary embodiment as described with reference to FIG. 3 and other drawings, the actual device 10b can be a proxy device 50 for the actual device 10a. The authentication unit 34, therefore, verifies the proxy relationship between the actual device 10b and the actual device 10a, that is, the actual device 10b is verified as the proxy device 50 for the actual device 10a (step S304).

After the authentication based on the first and second authentication requests is successfully completed, the authentication token issuing unit 35 issues an authentication token (hereinafter referred to as an “MFP1 authentication token”) as authentication information for authenticating the actual device 10a. The authentication unit 34 then notifies, in response to the proxy authentication performed by the proxy device 50, the proxy device 50 that the proxy authentication has been successfully completed by sending back the MFP1 authentication token, which has been issued since the second authentication request has led to a successful result, in addition to an MFP2 authentication token, which has been issued since the first authentication request has led to a successful result.

Here, the server 30 can recognize that the authentication request from the actual device 10b is for proxy authentication (step S501), and the actual device 10b just performs the proxy authentication and is not supposed to perform communication using the MFP2 authentication token. The authentication unit 34, therefore, need not send back the MFP2 authentication token.

Upon receiving the MFP1 authentication token from the server 30 in accordance with the proxy authentication, the proxy authentication unit 52 of the proxy device 50 transfers the MFP1 authentication token to the request device 40 (step S502).

Upon receiving the MFP1 authentication token in response to the proxy authentication request issued by the proxy authentication request unit 45 to the proxy device 50, the request device 40 can determine that the proxy authentication has been successfully completed. As a result, the actual device 10a issues a processing request to the server 30 while adding the received MFP1 authentication token to the processing request (step S404).

The reception unit 33 of the input unit 30 receives the processing request from the actual device 10a and the authentication unit 34 authenticates the actual device 10a using the MFP1 authentication token added to the processing request. Since the MFP1 authentication token is information corresponding to an authentication ticket transmitted to the proxy device 50 in step S306, the actual device 10a successfully completes the authentication performed by the server 30 even if a compromise of the private key “Owk1.key” of the actual device 10a has been detected (step S307).

According to the present exemplary embodiment, even if authentication of an actual device 10 with a private key is not successfully completed because a compromise of the private key has been detected, the server 30 can successfully authenticate the actual device 10 by requesting another actual device 10 holding an uncompromised private key to undergo authentication by proxy.

The administrator of the request device 40 may then create an owner authentication key of the request device 40 again so that the request device 40 can be successfully authenticated with a private key held thereby.

With the above-described proxy authentication, the request device 40 obtains an authentication token from the server 30 and is permitted to perform processing. Since the proxy device 50 that undergoes authentication by proxy is used and an authentication token has not been obtained using a legitimate method based on a private key, however, processing that can be performed between the actual device 10a and the server 30 may be given some restrictions.

For example, an authentication token obtained through proxy authentication may indicate that authentication is just temporarily successful, and processing that can be requested using the authentication token may be restricted. More specifically, the server 30 may permit processing for updating an algorithm for creating an owner authentication key again or processing an owner authentication key, that is, processing relating to version upgrades of the algorithm, and inhibit other types of processing.

In the proxy authentication, the proxy device 50 unconditionally performs proxy authentication in accordance with a proxy authentication request from the request device 40. In this case, no problem arises because the server 30 can check authenticity of the proxy authentication by referring to the proxy relationship information. When the proxy device 50 has obtained and held the same proxy relationship information as that held by the server 30, however, the proxy device 50 may determine, before performing the proxy authentication, whether to respond to a proxy authentication request by referring to the proxy relationship information held thereby.

The actual device 10a according to the present exemplary embodiment performs proxy authentication if a compromise of the private key “Owk1.key” has been detected, but the actual device 10a may perform proxy authentication for some reason even if a compromise of the private key “Owk1.key” has not been detected.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
a processor included in a server that manages second information processing apparatuses, each of which, if authentication with a pair of information for proving that the second information processing apparatus and one of first information processing apparatuses form a pair is successfully completed, is operable in conjunction with the first information processing apparatus, which holds one of the pair of information, and holds another of the pair of the information, the processor configured to:
   cause the server to hold proxy relationship information in which proxy relationships between the first information processing apparatuses are set;
   send back, if, after the processor receives, from a first information processing apparatus that operates as a proxy apparatus in accordance with a proxy authentication request from another first information processing apparatus that operates as a proxy authentication request apparatus, a first authentication request that specifies one of a pair of information held by the proxy apparatus and a second authentication request for authenticating the proxy authentication request apparatus, authentication with the pair of information specified by the first authentication request is successfully completed and the proxy apparatus is servable as a proxy apparatus for the proxy authentication request apparatus according to the proxy relationship information, authentication information for authenticating the proxy authentication request apparatus; and
   authenticate, if the authentication information sent back to the proxy apparatus is added to communication data transmitted from the proxy authentication request apparatus, the proxy authentication request apparatus, even if a compromise of the one of the pair of information held by the proxy authentication request apparatus has been detected.
(((2)))

The information processing system according to (((1))),
in which the processor is configured to create the proxy relationship information in accordance with a registration request transmitted from a first information processing apparatus for which a compromise of the one of the pair of information has not been detected and cause the server to hold the proxy relationship information.
(((3)))

The information processing system according to (((1))) or (((2))).
in which the processor is configured to create, if the first information processing apparatuses are classified into groups, the proxy relationship information for each group.
(((4)))

The information processing system according to (((3))),
in which the processor is configured to register, to proxy relationship information corresponding to a group identified by group identification information specified in the registration request, apparatus information for identifying the first information processing apparatus that has transmitted the registration request.
(((5)))

The information processing system according to (((2))),
in which the processor is configured to create, if the registration request specifies apparatus information for identifying the first information processing apparatus that operates as the proxy apparatus, proxy relationship information including the specified apparatus information and apparatus information for identifying the first information processing apparatus that has transmitted the registration request.
(((6)))

The information processing system according to (((2))) or (((5))),
in which the processor is configured to register, if proxy relationship information corresponding to the first information processing apparatus that has transmitted the registration request is already created in a case where the registration request specifies the apparatus information for identifying the first information processing apparatus that operates as the proxy apparatus, the apparatus information specified by the registration request to the proxy relationship information.
(((7)))

The information processing system according to (((2))),
in which the processor is configured to provide, if the proxy relationships between the first information processing apparatuses are set in the apparatus information for identifying the first information processing apparatus, the proxy relationship information for the first information processing apparatuses whose apparatus information is registered in the proxy relationship information.
(((8)))

The information processing system according to any one of (((1))) to (((7))),
in which the processor is configured to restrict, if the proxy authentication request apparatus is authenticated with not the one of the pair of information but the authentication information, processing performable between the proxy authentication request apparatus and the server.
(((9)))

The information processing system according to (((8))),
in which the performable processing is processing for updating an algorithm for creating the pair of information again or processing the pair of information.
(((10)))

The information processing system according to any one of (((1))) to (((9))),
in which the proxy apparatus includes a processor,
in which the processor included in the proxy apparatus is configured to:
   transmit the first authentication request and the second authentication request to the server in accordance with a proxy authentication request transmitted from the proxy authentication request apparatus; and
   transfer the authentication information sent back from the server in accordance with the second authentication request to the proxy authentication request apparatus.
(((11)))

The information processing system according to (((10))),
in which the processor included in the proxy apparatus is configured to:
   obtain the proxy relationship information from the server; and
   refer to the obtained proxy relationship information and determine whether to respond to the proxy authentication request from the proxy authentication request apparatus.
(((12)))

A program causing a computer that manages second information processing apparatuses, each of which, if authentication with a pair of information for proving that the second information processing apparatus and one of first information processing apparatuses form a pair is successfully completed, is operable in conjunction with the first information processing apparatus, which holds one of the pair of information, and holds another of the pair of the information, to execute a process comprising:
holding proxy relationship information in which proxy relationships between the first information processing apparatuses are set;
sending back, if, after receiving, from a first information processing apparatus that operates as a proxy apparatus in accordance with a proxy authentication request from another first information processing apparatus that operates as a proxy authentication request apparatus, a first authentication request that specifies one of a pair of information held by the proxy apparatus and a second authentication request for authenticating the proxy authentication request apparatus, authentication with the pair of information specified by the first authentication request is successfully completed and the proxy apparatus is servable as a proxy apparatus for the proxy authentication request apparatus according to the proxy relationship information, authentication information for authenticating the proxy authentication request apparatus; and
authenticating, if the authentication information sent back to the proxy apparatus is added to communication data transmitted from the proxy authentication request apparatus, the proxy authentication request apparatus, even if a compromise of the one of the pair of information held by the proxy authentication request apparatus has been detected.

What is claimed is:

1. An information processing system comprising:
a processor included in a server that manages second information processing apparatuses, each of which, if authentication with a pair of information for proving that the second information processing apparatus and one of first information processing apparatuses form a pair is successfully completed, is operable in conjunction with the first information processing apparatus, which holds one of the pair of information, and holds another of the pair of the information, the processor configured to:
cause the server to hold proxy relationship information in which proxy relationships between the first information processing apparatuses are set;
send back, if, after the processor receives, from a first information processing apparatus that operates as a proxy apparatus in accordance with a proxy authentication request from another first information processing apparatus that operates as a proxy authentication request apparatus, a first authentication request that specifies one of a pair of information held by the proxy apparatus and a second authentication request for authenticating the proxy authentication request apparatus, authentication with the pair of information specified by the first authentication request is successfully completed and the proxy apparatus is servable as a proxy apparatus for the proxy authentication request apparatus according to the proxy relationship information, authentication information for authenticating the proxy authentication request apparatus; and
authenticate, if the authentication information sent back to the proxy apparatus is added to communication data transmitted from the proxy authentication request apparatus, the proxy authentication request apparatus, even if a compromise of the one of the pair of information held by the proxy authentication request apparatus has been detected.

2. The information processing system according to claim 1,
wherein the processor is configured to create the proxy relationship information in accordance with a registration request transmitted from a first information processing apparatus for which a compromise of the one of the pair of information has not been detected and cause the server to hold the proxy relationship information.

3. The information processing system according to claim 2.
wherein the processor is configured to create, if the first information processing apparatuses are classified into groups, the proxy relationship information for each group.

4. The information processing system according to claim 3,
wherein the processor is configured to register, to proxy relationship information corresponding to a group identified by group identification information specified in the registration request, apparatus information for identifying the first information processing apparatus that has transmitted the registration request.

5. The information processing system according to claim 2,
wherein the processor is configured to create, if the registration request specifies apparatus information for identifying the first information processing apparatus that operates as the proxy apparatus, proxy relationship information including the specified apparatus information and apparatus information for identifying the first information processing apparatus that has transmitted the registration request.

6. The information processing system according to claim 5,
wherein the processor is configured to register, if proxy relationship information corresponding to the first information processing apparatus that has transmitted the registration request is already created in a case where the registration request specifies the apparatus information for identifying the first information processing apparatus that operates as the proxy apparatus, the apparatus information specified by the registration request to the proxy relationship information.

7. The information processing system according to claim 2,
wherein the processor is configured to provide, if the proxy relationships between the first information processing apparatuses are set in the apparatus information for identifying the first information processing apparatus, the proxy relationship information for the first information processing apparatuses whose apparatus information is registered in the proxy relationship information.

8. The information processing system according to claim 1,
wherein the processor is configured to restrict, if the proxy authentication request apparatus is authenticated with not the one of the pair of information but the authentication information, processing performable between the proxy authentication request apparatus and the server.

9. The information processing system according to claim 8,
wherein the performable processing is processing for updating an algorithm for creating the pair of information again or processing the pair of information.

10. The information processing system according to claim 1,
wherein the proxy apparatus includes a processor,
wherein the processor included in the proxy apparatus is configured to:
transmit the first authentication request and the second authentication request to the server in accordance with a proxy authentication request transmitted from the proxy authentication request apparatus; and
transfer the authentication information sent back from the server in accordance with the second authentication request to the proxy authentication request apparatus.

11. The information processing system according to claim 10,
wherein the processor included in the proxy apparatus is configured to:
obtain the proxy relationship information from the server; and
refer to the obtained proxy relationship information and determine whether to respond to the proxy authentication request from the proxy authentication request apparatus.

12. A non-transitory computer readable medium storing a program causing a computer that manages second information processing apparatuses, each of which, if authentication with a pair of information for proving that the second information processing apparatus and one of first information processing apparatuses form a pair is successfully completed, is operable in conjunction with the first information processing apparatus, which holds one of the pair of information, and holds another of the pair of the information, to execute a process comprising:
holding proxy relationship information in which proxy relationships between the first information processing apparatuses are set;
sending back, if, after receiving, from a first information processing apparatus that operates as a proxy apparatus in accordance with a proxy authentication request from another first information processing apparatus that operates as a proxy authentication request apparatus, a first authentication request that specifies one of a pair of information held by the proxy apparatus and a second authentication request for authenticating the proxy authentication request apparatus, authentication with the pair of information specified by the first authentication request is successfully completed and the proxy apparatus is servable as a proxy apparatus for the proxy authentication request apparatus according to the proxy relationship information, authentication information for authenticating the proxy authentication request apparatus; and
authenticating, if the authentication information sent back to the proxy apparatus is added to communication data transmitted from the proxy authentication request apparatus, the proxy authentication request apparatus, even if a compromise of the one of the pair of information held by the proxy authentication request apparatus has been detected.

13. A method used by a computer that manages second information processing apparatuses, each of which, if authentication with a pair of information for proving that the second information processing apparatus and one of first information processing apparatuses form a pair is successfully completed, is operable in conjunction with the first information processing apparatus, which holds one of the pair of information, and holds another of the pair of the information, the method comprising:
holding proxy relationship information in which proxy relationships between the first information processing apparatuses are set;
sending back, if, after receiving, from a first information processing apparatus that operates as a proxy apparatus in accordance with a proxy authentication request from another first information processing apparatus that operates as a proxy authentication request apparatus, a first authentication request that specifies one of a pair of information held by the proxy apparatus and a second authentication request for authenticating the proxy authentication request apparatus, authentication with the pair of information specified by the first authentication request is successfully completed and the proxy apparatus is servable as a proxy apparatus for the proxy authentication request apparatus according to the proxy relationship information, authentication information for authenticating the proxy authentication request apparatus; and
authenticating, if the authentication information sent back to the proxy apparatus is added to communication data transmitted from the proxy authentication request apparatus, the proxy authentication request apparatus, even if a compromise of the one of the pair of information held by the proxy authentication request apparatus has been detected.
